(19) United States
(12) Patent Application Publication
(10) Pub. No.: US 2024/0239286 A1
(43) Pub. Date: Jul. 18, 2024

(54) BUMPER FOR A MOBILE ROBOT

(71) Applicant: iRobot Corporation, Bedford, MA (US)

(72) Inventors: Brian W. Doughty, Framingham, MA (US); Andrew J. Pastore, Watertown, MA (US)

(21) Appl. No.: 18/096,676

(22) Filed: Jan. 13, 2023

(51) Int. Cl. B60R 19/48; B60R 19/02

(52) U.S. Cl. CPC B60R 19/483; B60R 19/023

(57) ABSTRACT

A method of detecting a location of an impact event for a mobile robot. The mobile robot can include a robot body and a bumper. The bumper configured to bend in response to an impact event. The method can include receiving a first signal from a proximity sensor attached to the robot body. The first signal can be indicative of a first distance between the bumper and the robot body at a first location of the bumper. The method can also include receiving a second signal from the proximity sensor attached to the robot body. The second signal can be indicative of a second distance between the bumper and the robot body at a second location of the bumper. The method can also include determining the location of the impact event by comparing the first signal and the second signal to at least one of a plurality of reference signals.

### TECHNICAL FIELD

Embodiments of the present disclosure generally relate to mobile robots. More specifically, embodiments of the present disclosure relate to a bumper system for a mobile robot.

### BACKGROUND

A mobile robot operates by navigating around an environment. The mobile robot can include a body, shell, or bumper that can contact obstacles that the mobile robot encounters during operation. The mobile robot can change its behavior in response to detecting an impact event with such an obstacle. For example, the mobile robot can back away from the obstacle or otherwise alter its path.

### SUMMARY

The present disclosure relates to mobile robots configured to travel across outdoor surfaces, e.g., grass, pavement, or the like, and indoor surfaces, e.g., wood, carpeting, rugs, tile flooring, or the like, and perform various operations. For example, the mobile robots can be used to mow the grass as the mobile robot travels across the lawn or can be used to clean the flooring as the mobile robot travels across the flooring. During operation, the mobile robots can encounter obstacles, which can impede their progress. For example, the robot may contact a post, a bird bath, a ramp, a wall, furniture, a ball, any item that is in or around the environment, or the like. The inventors have recognized the importance of identifying a location of these obstacles so that the mobile robot can change its course to get around the obstacle or so the mobile robot can avoid the obstacles in future operations.

The present disclosure describes devices and methods that can help identify a location of the objects engaged with during an impact event. The mobile robot can include a bumper that is fixed to the robot body. The bumper can include one or more magnets attached thereto and the robot body can include one or more sensors attached thereto. The bumper that is attached to the robot body can be configured to bend or deform upon the occurrence of an impact event. The sensors can detect the deformation of the bumper and output a signal indicative of such deformation. A controller can determine the location of the impact event on the bumper by analyzing the signal received from the sensors.

For example, this document describes a method of detecting a location of an impact event for a mobile robot. The mobile robot can include a robot body and a bumper. The bumper can be constrained with respect to the robot body to inhibit translation of an entirety of the bumper with respect to the robot body. The bumper can also extend at least a part of a periphery of the mobile robot. The bumper can be configured to bend in response to an impact event. Such bending of the bumper can include the bumper deforming in shape in response to the impact event, and then, after the impact event, deforming back to its original shape that existed before the impact event. The method can include receiving, with a processor, a first signal from a proximity sensor attached to the robot body. The first signal can be indicative of a first distance between the bumper and the robot body at a first location of the bumper. The method can also include receiving a second signal from the proximity sensor attached to the robot body. The second signal can be indicative of a second distance between the bumper and the robot body at a second location of the bumper. The method can also include determining the location of the impact event by comparing the first signal and the second signal to at least one of a plurality of reference signals.

### BRIEF DESCRIPTION OF THE DRAWINGS

Various embodiments are illustrated by way of example in the figures of the accompanying drawings. Such embodiments are demonstrative and not intended to be exhaustive or exclusive embodiments of the present subject matter.

FIG. 1 is an isometric view of an example of a mobile robot.

FIG. 2 is a bottom view of an example of a mobile robot.

FIG. 3 is an enlarged view of an example of a mobile robot showing an example of a bumper.

FIG. 4 is a top view of an example of a mobile robot impacting an object.

FIG. 5 is a schematic diagram showing the deformation of an example of a bumper for a mobile robot upon impact with an object.

FIG. 6 is an illustrative example of a graphical representation of an example of a bumper deformation data set.

FIG. 7 is a side view of an example of a mobile robot traveling through a grassy environment.

FIG. 8 is a graphical representation of an example of a bumper deformation data set when a mobile robot is traveling through a grassy environment.

FIG. 9 is a schematic view of a method of detecting an impact event for a mobile robot.

FIG. 10 is a block diagram illustrating an example of a mobile robot upon which one or more embodiments may be implemented.

### DETAILED DESCRIPTION

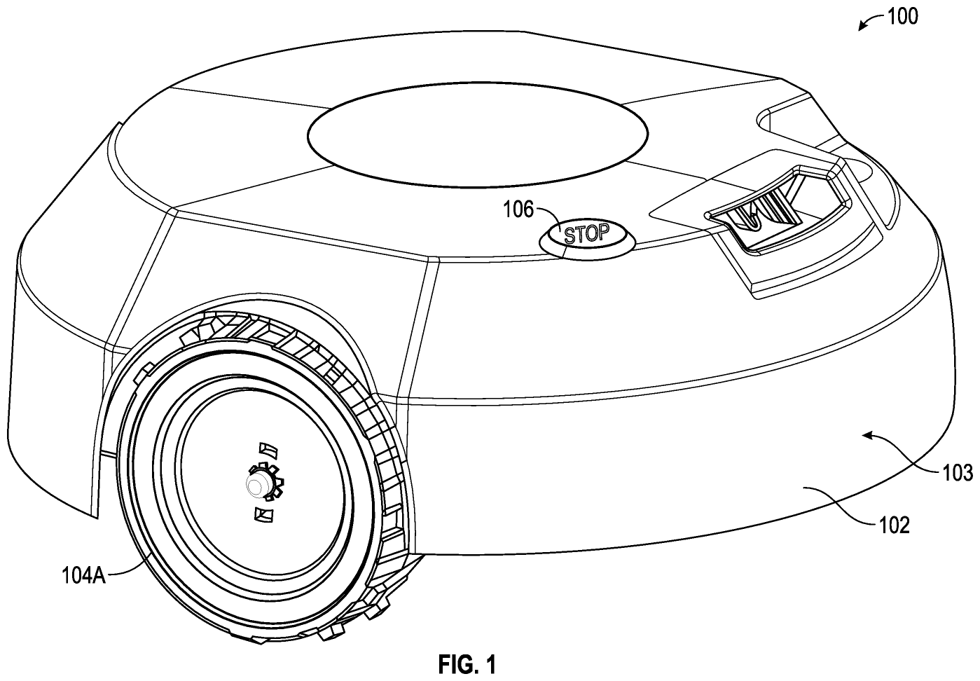

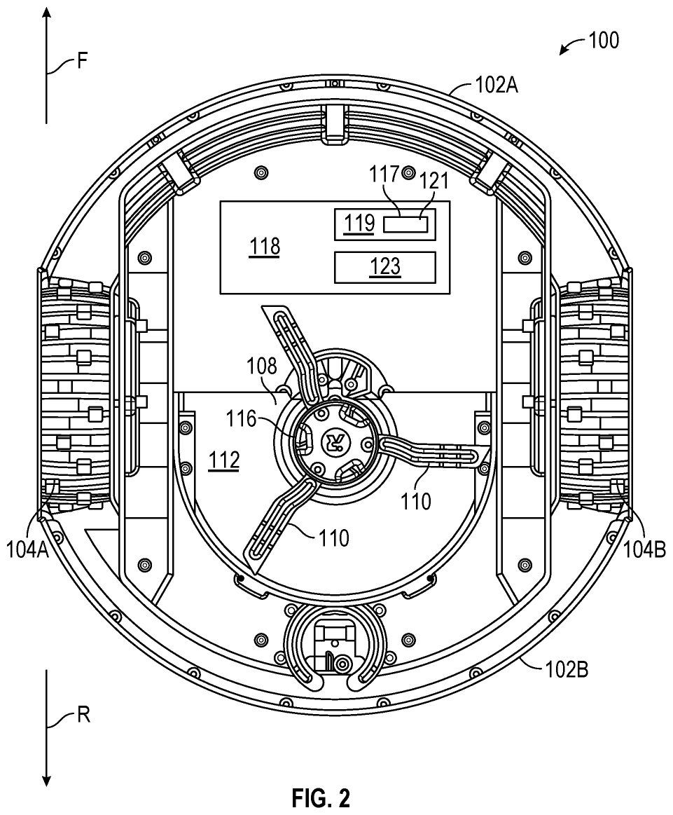

FIGS. 1 and 2 will be discussed together. FIG. 1 is an isometric view of an example of a mobile robot 100. FIG. 2 is a bottom view of an example of the mobile robot 100. FIG. 2 also includes directional indicators for forward (or front) F and rearward (or rear) R. The mobile robot 100 can be configured to mow a lawn. The mobile robot 100 can also be configured to detect contact with obstacles in the environment and can determine attributes of that contact. For example, the mobile robot 100 can determine a location of an object within the environment. The mobile robot 100 can also determine a location of an impact event between the mobile robot 100 and the obstacle. The location of the impact event can provide the mobile robot 100 with a route to navigate around the obstacle and avoid the obstacle during future operations. The mobile robot 100 can include a shell or bumper 102, wheels 104A and 104B (FIG. 2), a stop button 106, and a robot body 108. The stop button 106 can be configured to cease all operations of the mobile robot 100 upon being depressed. The mobile robot 100 can also include cutting blades 110 (FIG. 2), which are driven by a motor, for cutting grass. The blades 110 can be mounted on a cutting assembly 116 (FIG. 2) connected to the robot body 108.

The bumper 102 can define a periphery 103 of the mobile robot 100. As shown in FIGS. 1 and 2, the bumper 102 can extend around at least a portion of the periphery 103 of the mobile robot 100. For example, the mobile robot 100 can include a first bumper 102A (FIG. 2) and a second bumper 102B (FIG. 2). As shown in FIG. 2, the first bumper 102A can be a front bumper and the second bumper 102B can be a rear bumper. In another example, the first bumper 102A can span a first portion of a periphery of the mobile robot 100, and the second bumper 102B can span a second portion of the periphery of the mobile robot 100. In another example, the bumper 102 can extend around the entirety of the periphery 103 of the mobile robot 100. The bumper 102 can be connected to the robot body 108 such that the bumper 102 does not translate with respect to the body upon an impact event with an object. For example, the bumper 102 can be constrained with respect to the robot body 108 to inhibit translation of an entirety of the bumper 102 with respect to the robot body 108. Rather, the bumper 102 can be configured to bend or deform in response to the impact event. Such bending of the bumper 102 can include the bumper 102 deforming in shape in response to the impact event, and then, after the impact event, deforming back to its original shape that existed before the impact event. In another example, the bumper 102 and the robot body 108 can be one monolithic part such that the bumper 102 extends from the robot body 108.

The mobile robot 100 can include a drive system 112 (FIG. 2). The drive system 112 can be configured to turn the wheels 104. The drive system 112 can be configured to operate the wheels 104A and the wheels 104B (FIG. 2) separately. As such, the drive system 112 can include one or more motors in communication with a controller 118 (FIG. 2).

The controller 118 can include circuitry that can be configured to control the operations of the mobile robot 100. In examples, the controller 118 can be in communication with one or more sensors around the mobile robot 100. For example, the controller 118 can communicate with one or more image sensors, audio sensors, proximity sensors, accelerometers, motion sensors, or the like. The controller 118 can receive the signals from the sensors and determine how to operate the mobile robot 100. The controller 118 can include a memory 119.

The memory 119 (FIG. 2) can include circuitry that can store bumper deformation datasets 117 (FIG. 2). In an example, the stored bumper deformation datasets 117 can be stored on a reference database 121 (FIG. 2). Each individual reference bumper deformation data set of the reference bumper deformation datasets 117 can have a corresponding bumper location of impact. For example, the location of impact can be a location about the periphery 103 of the bumper 102.

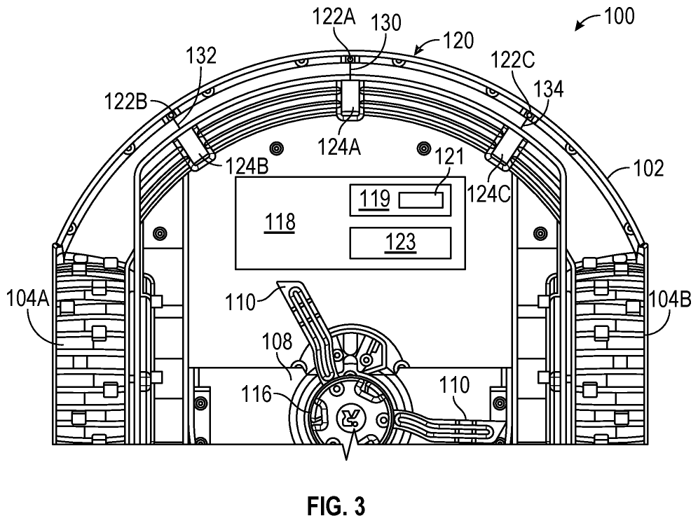

FIG. 3 is an enlarged view of an example of the mobile robot 100 showing an example of the bumper 102. The mobile robot 100 can include a bumper impact system 120. The bumper impact system 120 can be configured to detect an amount the bumper 102 bends or deforms around the mobile robot 100. As shown in FIG. 3, the mobile robot 100, and more specifically, the bumper impact system 120, can include magnets 122 (122A, 122B, 122C, . . . 122(N)), and sensors 124 (124A, 124B, 124C, . . . 122(N)). As shown in FIG. 3, the mobile robot 100 can include three of the magnets 122 and three of the sensors 124. In another example, the mobile robot 100 can include any number, such as four or more of the magnets 122 and four or more of the sensors 124, respectively. In yet another example, the mobile robot 100 can include two or fewer of the magnets 122 and two or fewer of the sensors 124, respectively.

The magnets 122 can be attached to the bumper 102. The magnets 122 can be spaced or distributed peripherally along the bumper 102. For example, the first magnet 122A can be located along the periphery 103 of the bumper 102 toward a front F portion of the bumper 102, the second magnet 122B can be peripherally spaced from the first magnet 122A counterclockwise along the periphery 103 of the bumper 102 toward the wheel 104A such that the second magnet 122B is less forward F than first magnet 122A, and the third magnet 122C can be peripherally spaced clockwise from the first magnet 122A periphery 103 toward the wheels 104B such that the third magnet 122C is less forward F than the first magnet 122A such that the magnets 122 can be detected by the sensors 124 as the bumper 102 deforms from an impact event. The sensors 124 can be attached to the robot body 108 with respect to the location of the magnets 122. For example, the sensors 124 can be spaced about the robot body 108 such that they can interact with the magnets 122 and detect movements of the magnets 122 as the bumper 102 bends or deforms.

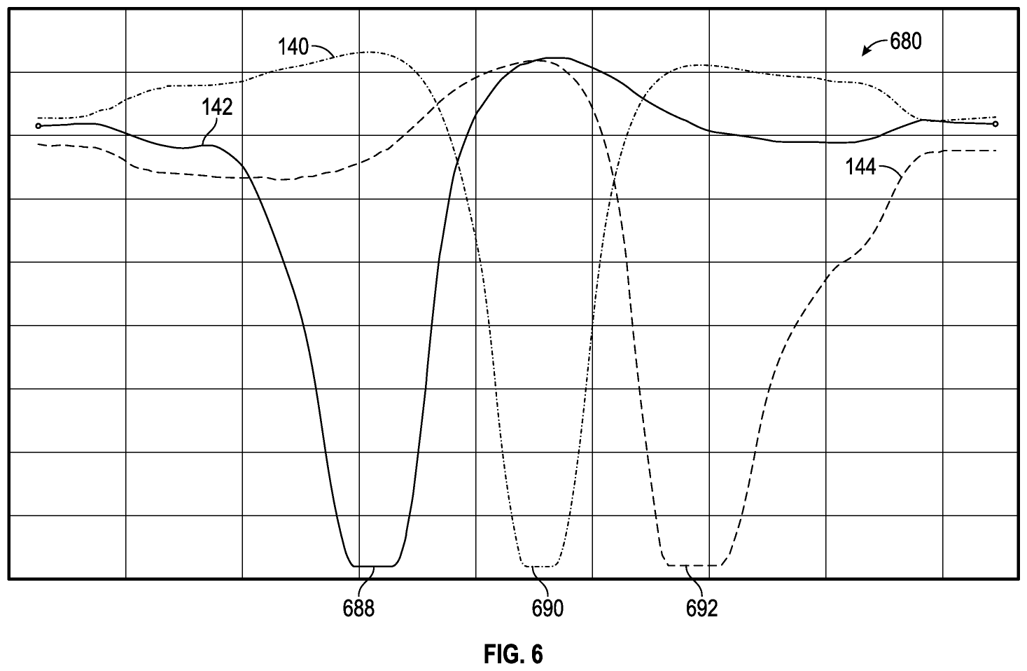

The sensors 124 can be attached to the robot body 108 such that the sensors 124 can detect a distance between the sensors 124 and each respective magnet of the magnets 122. For example, the first sensor 124A can be attached to the robot body 108 at a first distance 130 from the first magnet 122A, the second sensor 124B can be attached to the robot body 108 at a second distance 132 from the second magnet 122B, and the third sensor 124C can be attached to the robot body 108 at a third distance 134 from the third magnet 122C. Therefore, the sensors 124 can be configured to detect changes to the first distance 130, the second distance 132, or the third distance 134, due to bending or deformation of the bumper 102. The first sensor 124A can send a first signal 140 (first shown in FIG. 6) to the controller 118, the second sensor 124B can send a second signal 142 (first shown in FIG. 6) to the controller 118, and the third sensor 124C can send a third signal 144 (first shown in FIG. 6) to the controller 118. The first signal 140, the second signal 142, and the third signal 144 can be indicative of the first distance 130, the second distance 132, and the third distance 134, respectively.

For example, the sensors 124 can include Hall effect sensors. Hall effect sensors can generate a signal relative to a distance, e.g., the first distance 130, the second distance 132, or the third distance 134, between the respective sensor, e.g., the first sensor 124A, the second sensor 124B, or the third sensor 124C, and the respective magnet, e.g., the first magnet 122A, the second magnet 122B, or the third magnet 122C, respectively. The Hall effect sensors can provide a continuous signal that enables the controller 118 to continuously analyze a bending or deformation of the bumper 102. In another example, the location of the magnets 122 and the sensors 124 can be switched such that the magnets 122 are connected to the robot body 108 and the sensors 124 are peripherally distributed or spaced about the bumper 102. In yet another example, the sensors 124 can be another type of sensor, for example, ultrasonic sensor, laser sensor, optical sensor, mechanical displacement sensor, proximity sensor, any other type of sensor that can detect changes in distance between the bumper 102 and the robot body 108, or the like.

As shown in FIGS. 1-3, the mobile robot 100 can include a single bumper 102. In another example, the mobile robot 100 can include the first bumper 102A and the second bumper 102B. In an example, the first bumper 102A can be toward the front F (FIG. 2) of the mobile robot 100 and the second bumper 102B can be toward the rear R (FIG. 2) of the mobile robot 100. In examples, the first bumper 102A can include magnets 122 peripherally spaced along the periphery 103 of the first bumper 102A. The second bumper 102B can also include magnets 122 peripherally spaced along the periphery 103 of the second bumper 102B. In this example, the mobile robot 100 can also include sensors 124 spaced around the robot body 108 such as to determine a distance between the robot body 108 and each of the magnets 122. So, the mobile robot 100 can have sensors 124 relatively spaced to the magnets 122 to detect bending or deformation of the first bumper 102A or the 102B, respectively. Therefore, the sensors 124 can detect impact events while the mobile robot 100 is moving forward F (FIG. 2) and rearward R (FIG. 2).

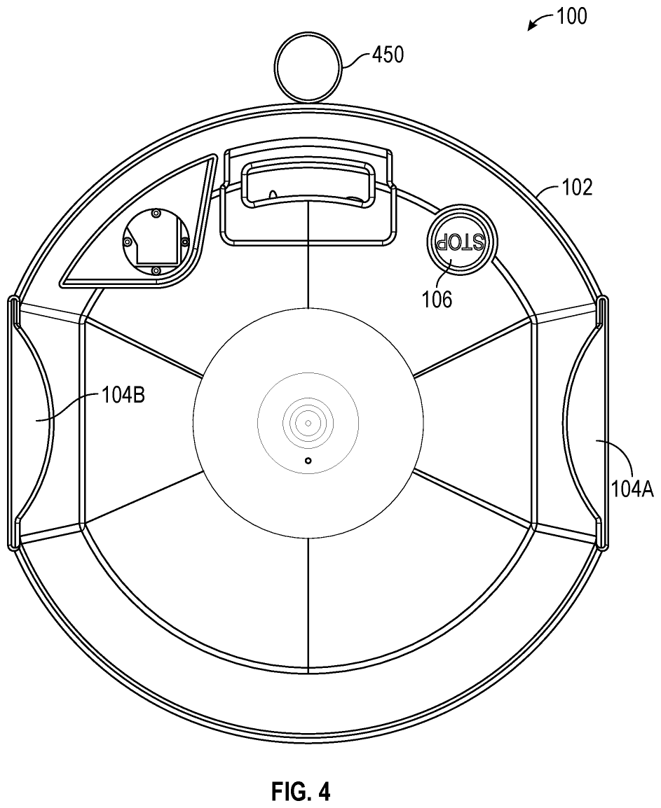

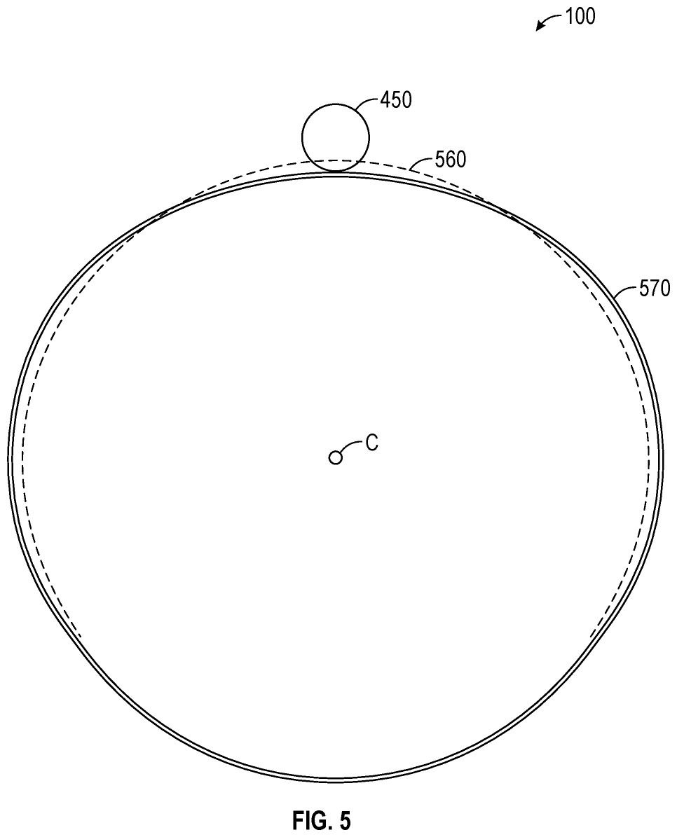

FIGS. 4 and 5 will be discussed together below. FIG. 4 is a top view of an example of mobile robot 100 impacting an object 450. FIG. 5 is a schematic diagram showing the bending or deformation of an example of a bumper, e.g., the bumper 102, for mobile robot 100 upon impact with the object 450. The mobile robot 100 can be configured such that the bumper 102 contacts an object 450 before any other portion of the mobile robot 100. As shown in the example shown in FIGS. 4 and 5, the impact event can occur when the mobile robot 100 contacts the object 450 when the object 450 is directly in front of the mobile robot 100. In another example, the impact event can be from contact with the object 450 along any portion of the periphery 103 of the bumper 102.

As shown in FIG. 5, as the bumper 102 contacts the object 450, the bumper 102 can be configured to bend or deform because the bumper 102 is attached to the robot body 108 in a manner that the bumper 102 bends or deforms without translating the entirety of the bumper with relation to the robot body 108. As such, the bumper 102 absorbs the impact of the impact event with the object 450. Because the entirety of the bumper 102 does not translate with relation to the robot body 108, the force of the impact event bends or deforms the bumper 102. As best shown in FIG. 5, the bumper 102 can have a non-deformed bumper 560 and a deformed bumper 570.

The non-deformed bumper 560 can be the bumper 102 when there are no external forces acting upon the bumper 102. For example, the non-deformed bumper 560 can be a lateral dimension, e.g., a diameter or any other dimension that defines a periphery of the bumper 102. The bumper 102 can be made from a material that includes elasticity such that the bumper 102 returns to the non-deformed bumper 560 after an impact event. The deformed bumper 570 can be a bent or deformed example of the bumper 102 during an impact event with the object 450. The portion of the bumper 102 impacted by the object 450 can bend or deform towards a center C of the mobile robot 100, and the portions of the bumper 102 that are peripherally spaced from the impact event can bend or deform away from the center C. The resulting deformation of the bumper 102 can result in the first sensor 124A readings indicating a reduction in the first distance 130 and can result in the second sensor 124B and the third sensor 124C readings indicating an increase in the second distance 132 and the third distance 134. Therefore, if the mobile robot 100 includes a system, e.g., the bumper impact system 120, that can continuously detect the bending or deformation of the bumper 102 at two or more points around the bumper 102, the bumper impact system 120 can send a bumper deformation data set to the controller 118 (FIGS. 2 and 3) for analysis.

FIG. 6 is an illustrative example of a graphical representation of an example of a bumper deformation data set (data set 680). The data set 680 can include a displacement, or distance, between the robot body and the bumper, as detected by the sensors 124. For example, the data set 680 can include a continuous feed of a first signal 140, a second signal 142, and a third signal 144, which can be indicative of the first distance 130 (FIG. 3), the second distance 132 (FIG. 3), and the third distance 134 (FIG. 3), respectively. The first signal 140 can be generated by the first sensor 124A (FIG. 3), the second signal 142 can be generated by the second sensor 124B (FIG. 3), and the third signal 144 can be generated by the third sensor 124C (FIG. 3).

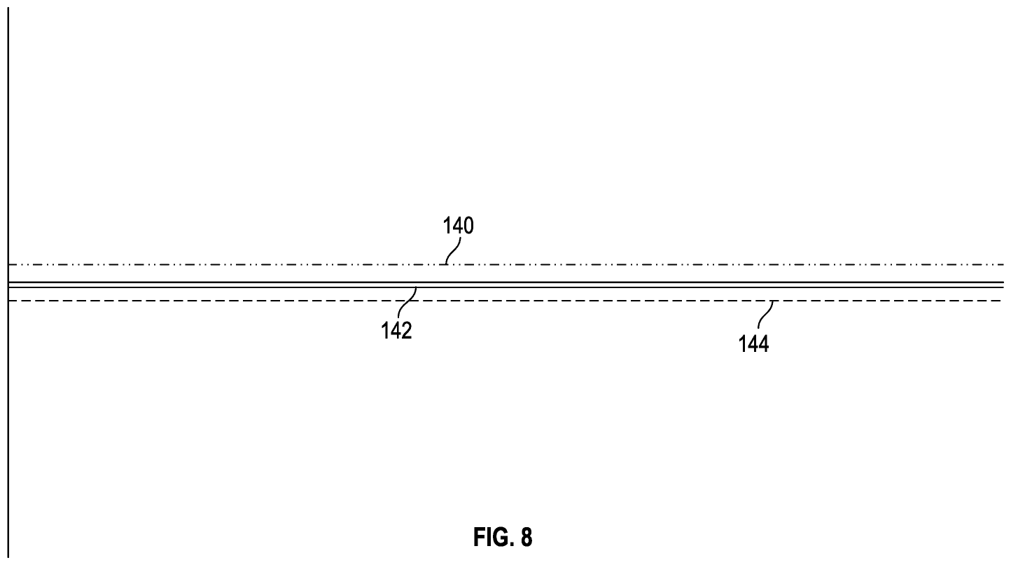

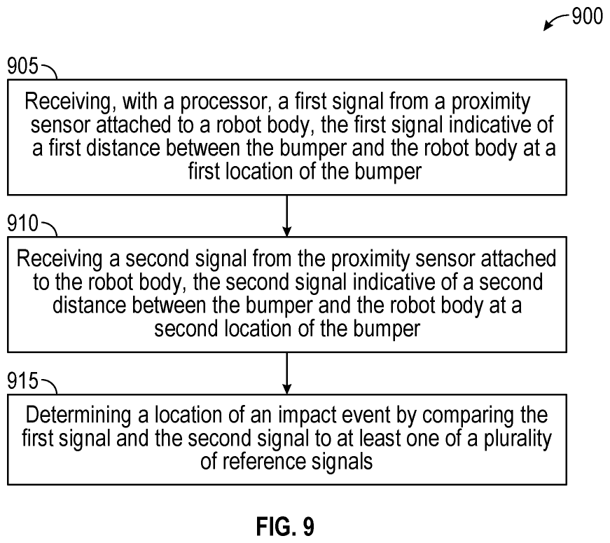

In examples, any vertical alignment between the first signal 140, the second signal 142, and the third signal 144 can represent an individual impact profile. As can be seen, there is never a repeating impact profile in the graphical representation of the data set 680. For example, each vertical from left to right can have a unique combination of the first signal 140, the second signal 142, and the third signal 144 that can relate to a specific location of impact around a periphery of the bumper of the mobile robot. Therefore, the sensors 124 provide reliable data that can be used to find a location of an impact even and the data set 680 can be an example of a reference to determine a location of a sensed impact event, which will be discussed below with reference to FIGS. 8 and 9.

A reference level for each of the signals, e.g., first signal 140, second signal 142, and third signal 144, can be seen towards the left and right edges of the graphical representation. The reference level can be an equilibrium signal for each of the sensor. In the graphical representation of the data set 680, deformation toward the center C is indicated by a negative value (below the reference level for each signal), and deformation away from the center C is indicated by a positive value (above the reference level for each signal). Therefore, if there is no object present, each of the first sensor 124A, the second sensor 124B, and the third sensor 124C will transmit the first signal 140, the second signal 142, and the third signal 144, respectively, can be equivalent to their respective reference level.

For the data set 680 illustrated in the graphical representation of FIG. 6, the data shows an example of the data set 680 if an impact event travels along the periphery 103 (FIG. 1) of the bumper 102 from a portion closest to the wheels 104A toward a portion closest to the wheels 104B. As can be seen, there are three large negative peaks, first peak 688, second peak 690, and third peak 692.

As can be seen in FIG. 6, when the impact event occurs in the portion of the bumper 102 nearest the 104A the first signal 140 starts to trend in a positive direction, which is indicative of bending or deforming away from the center C (FIG. 5), the second signal 142 starts to trend negative, which is indicative of bending or deforming towards the center C (FIG. 5), and the third signal 144 also starts to trend negative, which is indicative of bending or deforming towards the center C.

As the impact event moves from the portion of the bumper 102 adjacent the wheels 104A and toward the portion of the periphery 103 that the second magnet 122B (FIGS. 2 and 3), the first signal 140 can trend in a positive direction until about the time at which the first peak 688 occurs, the second signal 142 can continually trend negative until it reaches the first peak 688, the third signal 144 can trend slightly negative and can start trending in a positive direction toward its reference level at about the time at which the first peak 688 occurs.

As the impact event moves from the portion of the periphery 103 that the 122B is attached to the bumper 102 toward a portion of the periphery 103 that the 122C is attached to the bumper 102 the first signal 140 can continue to trend in a negative direction until about the time at which the second peak 690 occurs, the second signal 142 can continue to trend positive until about the time at which the second peak 690 occurs, and the third signal 144 can continue to trend in a positive direction until about the time at which the second peak 690 occurs.

As the impact event moves from the portion of the periphery 103 that the 122A is attached to the bumper 102 toward a portion of the periphery 103 that the third magnet 122C is attached to the bumper 102 the first signal 140 can trend in a positive direction until around the time of which the third peak 692 occurs, the second signal 142 can trend in a negative direction and can become negative around the time of which the third peak 692 occurs, and the third signal 144 can continue to trend in a negative direction until the second signal 142 reaches the third peak 692.

The graphical representation shown in FIG. 6 is just one non-limiting example of the signals that can be sent in the data set 680. The graphical representation of the data set 680 is dependent on the locations of the magnets 122 (FIGS. 2 and 3) and the sensors 124 (FIGS. 2 and 3) in the bumper 102 and the robot body 108, respectively. For examples, as the magnets 122 and the sensors 124 are respectively moved, the peaks, e.g., the first peak 688, the second peak 690, and the third peak 692 can move such that they are closer or farther from each other. Moreover, an intensity of the impact can influence a total amplitude of the first peak 688, the second peak 690, and the third peak 692. For example, the greater the intensity of the impact of the object on the bumper 102, the greater the amplitude of the peaks, and the less the intensity of the impact of the object on the bumper 102, the less the amplitude of the peaks.

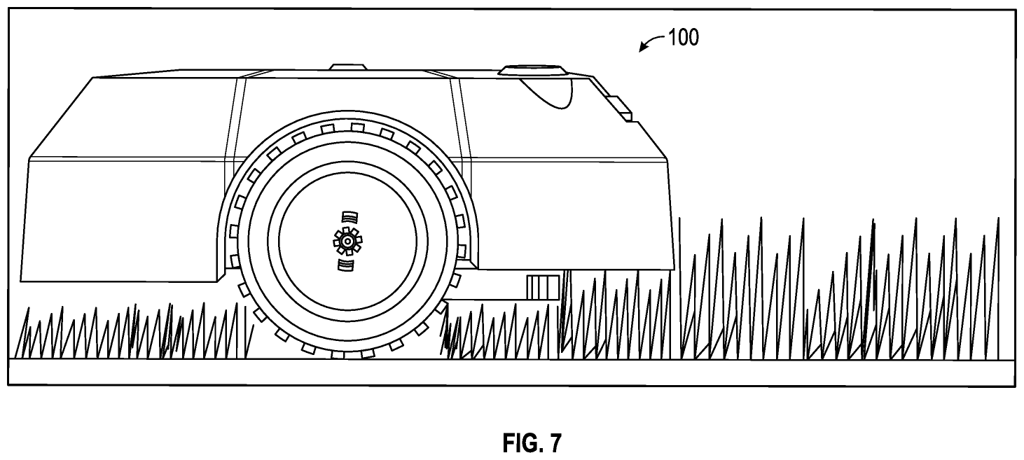

FIGS. 7 and 8 will be discussed together. FIG. 7 is a side view of an example of the mobile robot 100 traveling through a grassy environment. FIG. 8 is a graphical representation of an example of a bumper deformation data set, e.g., the data set 680, when the mobile robot 100 is traveling through a grassy environment.

As the mobile robot 100 travels across a yard, the grass can contact the bumper 102 of the mobile robot 100. However, because the contact of the grass against the bumper 102 can be uniform, the signals (first signal 140, second signal 142, and third signal 144) can also be uniform, as shown in FIG. 8. In the illustrative example shown in FIG. 8, the signals are perfectly flat; however, the inventors of the present disclosure recognize that there can be some variation in the signals while the mobile robot 100 contacts the grass. Thus, a range or series of data sets can be classified as grass contact. How the mobile robot 100, and more specifically, the controller 118 reacts to the grass contact will be discussed in more detail below with reference to FIG. 9.

FIG. 9 is a schematic view of a method 900 of detecting an impact event for a mobile robot. More specific examples of the method 900 are discussed below. The steps or operations of the method 900 are illustrated in a particular order for convenience and clarity; many of the discussed operations can be performed in a different sequence or in parallel without materially impacting other operations.

At operation 905, the method 900 can include receiving, with a processor, e.g., the controller 118 (FIG. 2), a first signal, e.g., the first signal 140 (first shown in FIG. 6), from a first sensor, e.g., first sensor 124A (first shown in FIG. 2) attached to the robot body, e.g., the robot body 108. As discussed above, the first signal 140 can indicate a first distance, e.g., the first distance 130 (FIG. 3), at a first location along the periphery 103 of the bumper 102. The first sensor can include a Hall effect sensor that can be configured to sense a first distance between a first magnet, e.g., the first magnet 122A, and the robot body. As discussed above, the first magnet can be attached to the bumper, e.g., bumper 102 (first shown in FIG. 1). The first magnet can be located toward a forward portion of the mobile robot.

At operation 910, the method 900 can include receiving a second signal, e.g., the second signal 142, from a proximity sensor, e.g., the first sensor 124A or the second sensor 124B (first shown in FIG. 2) attached to the robot body, e.g., the robot body 108. The second signal can be indicative of a second distance, e.g., the second distance 132 (FIG. 3), at a second location along the periphery 103 of the bumper 102. The second sensor can include a Hall effect sensor that can be configured to sense a second distance between a second magnet, e.g., the second magnet 122B, and the robot body. As discussed above, the second magnet can be attached to the bumper, e.g., bumper 102 (first shown in FIG. 1). The second magnet can be peripherally spaced counterclockwise from and less forward than the first magnet.

The method 900 can also include receiving a third signal, e.g., the third signal 144, from a third sensor, e.g., the first sensor 124A, the second sensor 124B, or the third sensor 124C (first shown in FIG. 2) attached to the robot body, e.g., the robot body 108. The third signal can be indicative of a third distance, e.g., the third distance 134 (FIG. 3), at a third location along the periphery 103 of the bumper 102. The third sensor can include a Hall effect sensor that can be configured to sense a third distance between a third magnet, e.g., the third magnet 122C, and the robot body. As discussed above, the third magnet can be attached to the bumper, e.g., bumper 102 (first shown in FIG. 1). The third magnet can be peripherally spaced clockwise from and less forward than the first magnet.

At operation 915, the method 900 can include determining a location of an impact event by comparing the first signal and the second signal to at least one of a plurality of reference signals.

The mobile robot, e.g., the mobile robot 100, can include a memory, e.g., the memory 119. The memory 119 can include stored reference bumper deformation datasets. Each of the reference bumper deformation datasets can have a corresponding bumper location of impact. In an example, the reference signals can be stored on a reference database, e.g., the reference database 121 (FIG. 2). The memory 119 can also include programs or instructions that can be run by the processor to control the mobile robot.

The processor of the mobile robot can generate an impact profile with the first signal, the second signal, and the third signal. For example, FIGS. 6 and 8 can be graphical representations of the impact profile generated by the processor. The processor can then compare the impact profile with the reference deformation data sets to determine the location of the impact event. For example, the processor can determine the location of the impact event on condition that the impact profile corresponds to at least one reference signal of the plurality of reference signals.

The method 900 can also include determining a uniform impact across the bumper on condition that the impact profile corresponds to at least one of the plurality of reference signals. If the impact profile is similar to the graphical representation shown in FIG. 8, for example, the impact profile can correspond to at least one of the plurality of reference signals that is identified as a grass impact. The method 900 can also include ignoring the impact event on condition that the impact event is identified as grass. As the mobile robot ignores the impact event, the mobile robot can continue to move and complete operations, such as, mowing the lawn, until the task is complete, the stop button is depressed (or the mobile robot receives a stop command from any other source such as a mobile device of a user), or until another impact event occurs.

The method 900 can also include tracking a geographic location of the mobile robot with a positioning sensor, e.g., the GPS 123, as the mobile robot moves about an environment. The method 900 can also include determining the geographic location of the mobile robot during the impact event. The method 900 can also include storing the geographic location of the mobile robot during the impact event on the memory. Here, the mobile robot can use the stored location of the impact event to alter future operations completed by the robot. For example, if the mobile robot is working in a yard and impacts a fence post, deck, or any other fixture in the yard, or the like, the mobile robot can remember the location of the impact event and avoid that location in future runs.

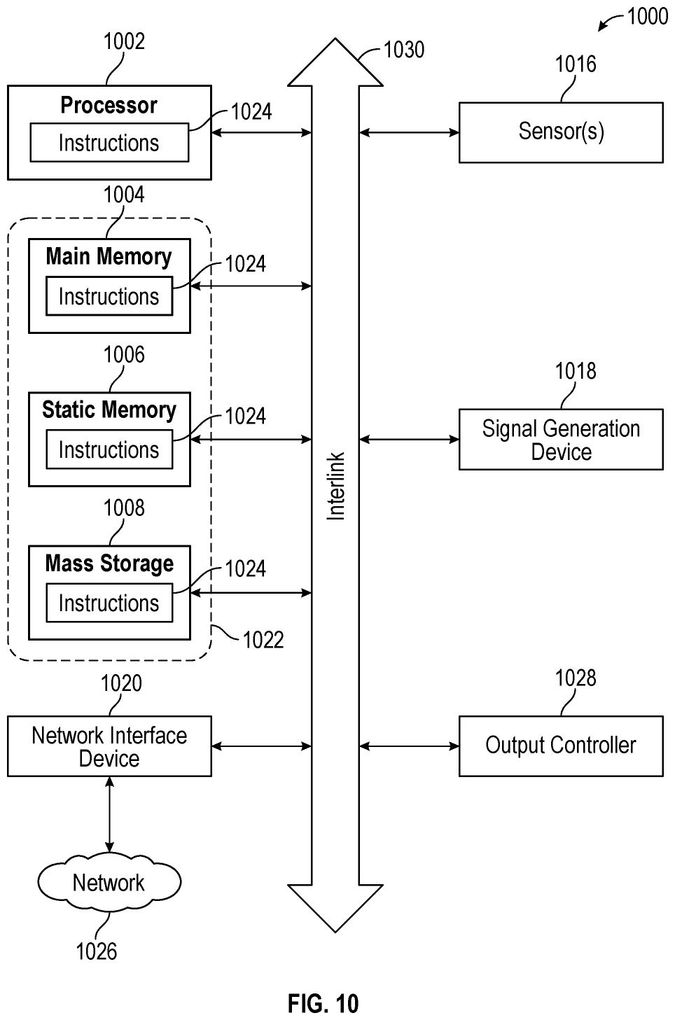

FIG. 10 illustrates a block diagram of implemented an example mobile robot 1000, e.g., the mobile robot 100 (first shown in FIG. 1), upon which any one or more of the techniques, e.g., methodologies, discussed herein may perform. Examples, as described herein, may include, or may operate by, logic or a number of components, or mechanisms in the mobile robot 1000. Circuitry, e.g., processing circuitry, is a collection of circuits implemented in tangible entities of the mobile robot 1000 that include hardware, e.g., simple circuits, gates, logic, or the like. Circuitry membership may be flexible over time. Circuitries include members that may, alone or in combination, perform specified operations when operating. In an example, hardware of the circuitry may be immutably designed to conduct a specific operation, e.g., hardwired. In an example, the hardware of the circuitry may include variably connected physical components, e.g., execution units, transistors, simple circuits, or the like, including a machine-readable medium physically modified, e.g., magnetically, electrically, moveable placement of invariant massed particles, or the like, to encode instructions of the specific operation. In connecting the physical components, the underlying electrical properties of a hardware constituent are changed, for example, from an insulator to a conductor or vice versa. The instructions enable embedded hardware, e.g., the execution units or a loading mechanism, to create members of the circuitry in hardware via the variable connections to conduct portions of the specific operation when in operation. Accordingly, in an example, the machine-readable medium elements are part of the circuitry or are communicatively coupled to the other circuitry components when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the mobile robot 1000 follow.

In alternative embodiments, the mobile robot 1000 may operate as a standalone device or may be connected, e.g., networked, to other machines. In a networked deployment, the mobile robot 1000 may operate in the capacity of a server machine, a client machine, or both in server-client network environments. In an example, the mobile robot 1000 may act as a peer machine in peer-to-peer (P2P) (or other distributed) network environment. The mobile robot 1000 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The mobile robot (e.g., machine) 1000 may include a hardware processor 1002 (e.g., a central processing unit (CPU), a graphics processing unit (GPU), a hardware processor core, or any combination thereof), a main memory 1004, a static memory, e.g., memory or storage for firmware, microcode, a basic-input-output (BIOS), unified extensible firmware interface (UEFI), or the like, 1006, and mass storage 1008, e.g., hard drives, tape drives, flash storage, or other block devices, some or all of which may communicate with each other via an interlink 130, e.g., bus.

The mobile robot 1000 may include a storage device 1008, a signal generation device 1018, e.g., a speaker, a network interface device 1020, and one or more sensors 1016, such as a global positioning system (GPS) sensor, compass, accelerometer, or other sensor. The mobile robot 1000 may include an output controller 1028, such as a serial (e.g., universal serial bus (USB), parallel, or other wired or wireless, e.g., infrared (IR), near field communication (NFC), or the like, connection to communicate or control one or more peripheral devices, e.g., a printer, card reader, or the like.

Registers of the processor 1002, the main memory 1004, the static memory 1006, or the mass storage 1008 may be, or include, a machine-readable medium 1022 on which is stored one or more sets of data structures or instructions 1024, e.g., software, embodying or utilized by any one or more of the techniques or functions described herein. The instructions 1024 may also reside, completely or at least partially, within any of registers of the processor 1002, the main memory 1004, the static memory 1006, or the mass storage 1008 during execution thereof by the mobile robot 1000. In an example, one or any combination of the hardware processor 1002, the main memory 1004, the static memory 1006, or the mass storage 1008 may constitute the machine readable media 1022. While the machine readable medium 1022 is illustrated as a single medium, the term “machine-readable medium” may include a single medium or multiple media, e.g., a centralized or distributed database, or associated caches and servers, configured to store the one or more instructions 1024.

The term “machine-readable medium” may include any medium that is capable of storing, encoding, or carrying instructions for execution by the mobile robot 1000 and that cause the mobile robot 1000 to perform any one or more of the techniques of the present disclosure, or that is capable of storing, encoding or carrying data structures used by or associated with such instructions. Non-limiting machine-readable medium examples may include solid-state memories, optical media, magnetic media, and signals, e.g., radio frequency signals, other photon-based signals, sound signals, or the like. In an example, a non-transitory machine-readable medium comprises a machine-readable medium with a plurality of particles having invariant, e.g., rest, mass, and thus, are compositions of matter. Accordingly, non-transitory machine-readable media are machine-readable media that do not include transitory propagating signals. Specific examples of non-transitory machine-readable media may include: non-volatile memory, such as semiconductor memory devices, e.g., Electrically Programmable Read-Only Memory (EPROM), Electrically Erasable Programmable Read-Only Memory (EEPROM), and flash memory devices; magnetic disks, such as internal hard disks and removable disks; magneto-optical disks; and CD-ROM and DVD-ROM disks.

In an example, information stored or otherwise provided on the machine-readable medium 1022 may be representative of the instructions 1024, such as instructions 1024 themselves or a format from which the instructions 1024 may be derived. This format from which the instructions 1024 may be derived may include source code, encoded instructions, e.g., in compressed or encrypted form, packaged instructions, e.g., split into multiple packages, or the like. The information representative of the instructions 1024 in the machine-readable medium 1022 may be processed by processing circuitry into the instructions to implement any of the operations discussed herein. For example, deriving the instructions 1024 from the information, e.g., processing by the processing circuitry may include: compiling, e.g., from source code, object code, or the like, interpreting, loading, organizing, e.g., dynamically or statically linking, encoding, decoding, encrypting, unencrypting, packaging, unpackaging, or otherwise manipulating the information into the instructions 1024.

In an example, the derivation of the instructions 1024 may include assembly, compilation, or interpretation of the information, e.g., by the processing circuitry, to create the instructions 1024 from some intermediate or preprocessed format provided by the machine-readable medium 1022. When provided in multiple parts, the information may be combined, unpacked, and modified to create the instructions 1024. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted, e.g., into a library, stand-alone executable, or the like, at a local machine, and executed by the local machine.

The instructions 1024 may be further transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks, e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 1020 may include one or more physical jacks, e.g., Ethernet, coaxial, or phone jacks, or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the mobile robot 1000, and includes digital or analog communications signals or other intangible medium to facilitate communication of such software. A transmission medium is a machine-readable medium.

The following, non-limiting examples, detail certain aspects of the present subject matter to solve the challenges and provide the benefits discussed herein, among others.

Example 1 is a mobile robot comprising: a robot body; a drive system supporting the robot body above a floor surface for maneuvering the mobile robot across the floor surface; a bumper, constrained with respect to the robot body to inhibit translation of an entirety of the bumper with respect to the robot body and extending at least a part of a periphery of the mobile robot, the bumper configured to bend in response to an impact event; and a bumper impact system including a proximity sensor configured to: generate a first signal indicative of a first distance between the robot body and the bumper; and generate a second signal indicative of a second distance between the robot body and the bumper, a change to at least one of the first distance or the second distance indicating bending of the bumper due to the impact event without requiring translation of the entirety of the bumper with respect to the robot body.

In Example 2, the subject matter of Example 1 includes, wherein the bumper extends around an entire periphery of the mobile robot.

In Example 3, the subject matter of Examples 1-2 includes, wherein the proximity sensor comprises: a first proximity sensor attached to the robot body and configured to generate the first signal indicative of a first distance between the robot body and the bumper; and a second proximity sensor attached to the robot body and configured to generate a second signal indicative of the second distance between the robot body and the bumper, and wherein the second proximity sensor peripherally spaced from the first proximity sensor along a periphery of the robot body.

In Example 4, the subject matter of Example 3 includes, wherein the proximity sensor comprises: a third proximity sensor attached to the robot body and configured to generate a third signal indicative of a third distance between the robot body and the bumper.

In Example 5, the subject matter of Example 4 includes, wherein the bumper comprises: a first magnet attached to the bumper; a second magnet attached to the bumper; and a third magnet attached to the bumper; wherein the first magnet, the second magnet, and the third magnet are peripherally spaced along the bumper.

In Example 6, the subject matter of Example 5 includes, a memory including stored reference bumper deformation datasets, an individual reference bumper deformation data set of the reference bumper deformation datasets having a corresponding bumper location of impact.

In Example 7, the subject matter of Example 6 includes, a processor configured to determine a location of the impact event by comparing the first signal and the second signal to at least one of the reference bumper deformation datasets.

In Example 8, the subject matter of Example 7 includes, wherein the processor combines the first signal, the second signal, and the third signal to generate an impact profile.

In Example 9, the subject matter of Example 8 includes, wherein the processor compares the impact profile to one or more of the reference bumper deformation datasets to determine the location of the impact event on condition that the impact profile corresponds to at least one of the reference bumper deformation datasets.

In Example 10, the subject matter of Example 9 includes, wherein the location of the impact event is the corresponding bumper location of impact for one or more of the corresponding reference bumper deformation datasets.

In Example 11, the subject matter of Examples 7-10 includes, a second bumper extending from the robot body and extending at least a part of the periphery of the mobile robot, the bumper configured to bend in response to the impact event, wherein the second bumper is attached to the robot body opposite the bumper; and one or more reference second bumper deformation datasets stored on the memory, an individual reference second bumper deformation data set of the reference second bumper deformation datasets having a corresponding second bumper location of impact.

In Example 12, the subject matter of Example 11 includes, wherein the second bumper comprises: a fourth magnet attached to the second bumper; a fifth magnet attached to the second bumper; and a sixth magnet attached to the second bumper; wherein the fourth magnet, the fifth magnet, and the sixth magnet are peripherally spaced along the second bumper.

In Example 13, the subject matter of Example 12 includes, wherein the bumper impact system comprises: a fourth proximity sensor attached to the robot body and configured to generate a fourth signal indicative of a fourth distance between the robot body and the second bumper; a fifth proximity sensor attached to the robot body and configured to generate a fifth signal indicative of a fifth distance between the robot body and the second bumper; and a sixth proximity sensor attached to the robot body and configured to generate a sixth signal indicative of a sixth distance between the robot body and the second bumper; wherein the fourth proximity sensor, the fifth proximity sensor, and the sixth proximity sensor are peripherally spaced along the periphery of the robot body, and wherein changes to the fourth distance, the fifth distance, or the sixth distance indicate the deformation of the second bumper from the impact event.

In Example 14, the subject matter of Example 13 includes, wherein the processor combines the fourth signal, the fifth signal, and the sixth signal to generate a second impact profile, and wherein the processor compares the second impact profile to one or more of the reference second bumper deformation datasets, and wherein the processor finds the location of the impact event on condition that the second impact profile corresponds to at least one of the reference second bumper deformation datasets.

In Example 15, the subject matter of Examples 1-14 includes, wherein the bumper and the robot body are one monolithic part.

Example 16 is a method of detecting a location of an impact event for a mobile robot, the mobile robot including a robot body and a bumper constrained with respect to the robot body to inhibit translation of an entirety of the bumper with respect to the robot body and extending at least a part of a periphery of the mobile robot, the bumper configured to bend in response to an impact event the method comprising: receiving, with a processor, a first signal from a proximity sensor attached to the robot body, the first signal indicative of a first distance between the bumper and the robot body at a first location of the bumper; receiving a second signal from the proximity sensor attached to the robot body, the second signal indicative of a second distance between the bumper and the robot body at a second location of the bumper; and determining the location of the impact event by comparing the first signal and the second signal to at least one of a plurality of reference signals.

In Example 17, the subject matter of Example 16 includes, receiving a third signal from the proximity sensor attached to the robot body, the third signal indicates a third distance between the bumper and the robot body at a third location of the bumper.

In Example 18, the subject matter of Example 17 includes, wherein the proximity sensor comprises: a first sensor including a Hall effect sensor configured to sense a first distance between a first magnet and the robot body; a second sensor including a Hall effect sensor configured to sense a second distance between a second magnet and the robot body; and a third sensor including a Hall effect sensor configured to sense a third distance between a third magnet and the robot body; wherein the first magnet, the second magnet, and the third magnet are attached to the bumper.

In Example 19, the subject matter of Example 18 includes, wherein the first magnet is located toward a forward portion of the mobile robot, the second magnet is peripherally spaced counterclockwise from and less forward than the first magnet, and the third magnet is peripherally spaced clockwise from and less forward than the first magnet.

In Example 20, the subject matter of Example 19 includes, generating an impact profile with the first signal, the second signal, and the third signal.

In Example 21, the subject matter of Example 20 includes, wherein the reference signals are stored on a reference database.

In Example 22, the subject matter of Example 21 includes, determining a location of the impact event on condition that the impact profile corresponds to at least one reference signal of the plurality of reference signals.

In Example 23, the subject matter of Example 22 includes, determining a uniform impact across the bumper on condition that the impact profile corresponds to at least one of the plurality of reference signals; identifying the impact event as grass; and ignoring the impact event on condition that the impact event is identified as grass.

In Example 24, the subject matter of Examples 16-23 includes, tracking a geographic location of the mobile robot as the mobile robot moves about an environment with a positioning sensor; determining the geographic location of the mobile robot during the impact event; and storing the geographic location of the mobile robot during the impact event on a memory.

Example 25 is at least one machine-readable medium including instructions that, when executed by processing circuitry, cause the processing circuitry to perform operations to implement of any of Examples 1-24.

Example 26 is an apparatus comprising means to implement of any of Examples 1-24.

Example 27 is a system to implement of any of Examples 1-24.

Example 28 is a method to implement of any of Examples 1-24.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g. 1 to 5 includes 1, 1.5, 2, 2.75, 3, 3.90, 4, 4.24, and 5). Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A mobile robot comprising:
a robot body;
a drive system supporting the robot body above a floor surface for maneuvering the mobile robot across the floor surface;
a bumper, constrained with respect to the robot body to inhibit translation of an entirety of the bumper with respect to the robot body and extending at least a part of a periphery of the mobile robot, the bumper configured to bend in response to an impact event; and
a bumper impact system including a proximity sensor configured to:
generate a first signal indicative of a first distance between the robot body and the bumper; and
generate a second signal indicative of a second distance between the robot body and the bumper, a change to at least one of the first distance or the second distance indicating bending of the bumper due to the impact event without requiring translation of the entirety of the bumper with respect to the robot body.

2. The mobile robot of claim 1, wherein the bumper extends around an entire periphery of the mobile robot.

3. The mobile robot of claim 1, wherein the proximity sensor comprises:
a first proximity sensor attached to the robot body and configured to generate the first signal indicative of a first distance between the robot body and the bumper; and
a second proximity sensor attached to the robot body and configured to generate a second signal indicative of the second distance between the robot body and the bumper, and wherein the second proximity sensor peripherally spaced from the first proximity sensor along a periphery of the robot body.

4. The mobile robot of claim 3, wherein the proximity sensor comprises:
a third proximity sensor attached to the robot body and configured to generate a third signal indicative of a third distance between the robot body and the bumper.

5. The mobile robot of claim 4, wherein the bumper comprises:
a first magnet attached to the bumper;
a second magnet attached to the bumper; and
a third magnet attached to the bumper;
wherein the first magnet, the second magnet, and the third magnet are peripherally spaced along the bumper.

6. The mobile robot of claim 5, comprising:
a memory including stored reference bumper deformation datasets, an individual reference bumper deformation data set of the reference bumper deformation datasets having a corresponding bumper location of impact.

7. The mobile robot of claim 6, comprising:
a processor configured to determine a location of the impact event by comparing the first signal and the second signal to at least one of the reference bumper deformation datasets.

8. The mobile robot of claim 7, wherein the processor combines the first signal, the second signal, and the third signal to generate an impact profile.

9. The mobile robot of claim 8, wherein the processor compares the impact profile to one or more of the reference bumper deformation datasets to determine the location of the impact event on condition that the impact profile corresponds to at least one of the reference bumper deformation datasets.

10. The mobile robot of claim 9, wherein the location of the impact event is the corresponding bumper location of impact for one or more of the corresponding reference bumper deformation datasets.

11. The mobile robot of claim 7, comprising:
a second bumper extending from the robot body and extending at least a part of the periphery of the mobile robot, the bumper configured to bend in response to the impact event, wherein the second bumper is attached to the robot body opposite the bumper; and
one or more reference second bumper deformation datasets stored on the memory, an individual reference second bumper deformation data set of the reference second bumper deformation datasets having a corresponding second bumper location of impact.

12. The mobile robot of claim 11, wherein the second bumper comprises:
a fourth magnet attached to the second bumper;
a fifth magnet attached to the second bumper; and
a sixth magnet attached to the second bumper;
wherein the fourth magnet, the fifth magnet, and the sixth magnet are peripherally spaced along the second bumper.

13. The mobile robot of claim 12, wherein the bumper impact system comprises:
a fourth proximity sensor attached to the robot body and configured to generate a fourth signal indicative of a fourth distance between the robot body and the second bumper;
a fifth proximity sensor attached to the robot body and configured to generate a fifth signal indicative of a fifth distance between the robot body and the second bumper; and
a sixth proximity sensor attached to the robot body and configured to generate a sixth signal indicative of a sixth distance between the robot body and the second bumper;
wherein the fourth proximity sensor, the fifth proximity sensor, and the sixth proximity sensor are peripherally spaced along the periphery of the robot body, and wherein changes to the fourth distance, the fifth distance, or the sixth distance indicate the deformation of the second bumper from the impact event.

14. The mobile robot of claim 13, wherein the processor combines the fourth signal, the fifth signal, and the sixth signal to generate a second impact profile, and wherein the processor compares the second impact profile to one or more of the reference second bumper deformation datasets, and wherein the processor finds the location of the impact event on condition that the second impact profile corresponds to at least one of the reference second bumper deformation datasets.

15. The mobile robot of claim 1, wherein the bumper and the robot body are one monolithic part.

16. A method of detecting a location of an impact event for a mobile robot, the mobile robot including a robot body and a bumper constrained with respect to the robot body to inhibit translation of an entirety of the bumper with respect to the robot body and extending at least a part of a periphery of the mobile robot, the bumper configured to bend in response to an impact event the method comprising:
receiving, with a processor, a first signal from a proximity sensor attached to the robot body, the first signal indicative of a first distance between the bumper and the robot body at a first location of the bumper;
receiving a second signal from the proximity sensor attached to the robot body, the second signal indicative of a second distance between the bumper and the robot body at a second location of the bumper; and
determining the location of the impact event by comparing the first signal and the second signal to at least one of a plurality of reference signals.

17. The method of claim 16, comprising:
receiving a third signal from the proximity sensor attached to the robot body, the third signal indicates a third distance between the bumper and the robot body at a third location of the bumper.

18. The method of claim 17, wherein the proximity sensor comprises:
a first sensor including a Hall effect sensor configured to sense a first distance between a first magnet and the robot body;
a second sensor including a Hall effect sensor configured to sense a second distance between a second magnet and the robot body; and
a third sensor including a Hall effect sensor configured to sense a third distance between a third magnet and the robot body;
wherein the first magnet, the second magnet, and the third magnet are attached to the bumper.

19. The method of claim 18, wherein the first magnet is located toward a forward portion of the mobile robot, the second magnet is peripherally spaced counterclockwise from and less forward than the first magnet, and the third magnet is peripherally spaced clockwise from and less forward than the first magnet.

20. The method of claim 19, comprising:
generating an impact profile with the first signal, the second signal, and the third signal.

21. The method of claim 20, wherein the reference signals are stored on a reference database.

22. The method of claim 21, comprising:
determining a location of the impact event on condition that the impact profile corresponds to at least one reference signal of the plurality of reference signals.

23. The method of claim 22, comprising:
determining a uniform impact across the bumper on condition that the impact profile corresponds to at least one of the plurality of reference signals;
identifying the impact event as grass; and
ignoring the impact event on condition that the impact event is identified as grass.

24. The method of claim 16, comprising:
tracking a geographic location of the mobile robot as the mobile robot moves about an environment with a positioning sensor;
determining the geographic location of the mobile robot during the impact event; and
storing the geographic location of the mobile robot during the impact event on a memory.
